(19) United States
(12) Patent Application Publication
(10) Pub. No.: US 2016/0275545 A1
(43) Pub. Date: Sep. 22, 2016

(54) METHODS AND SYSTEMS FOR USING DEVICE CONNECTIVITY INFORMATION IN ON-LINE ADVERTISING

(71) Applicant: Turn Inc., Redwood City, CA (US)

(72) Inventors: Ali Dasdan, San Jose, CA (US); Santanu Kumar Kolay, San Jose, CA (US); Sumit Rangwala, Fremont, CA (US)

(73) Assignee: Turn Inc., Redwood City, CA (US)

(21) Appl. No.: 14/662,496

(22) Filed: Mar. 19, 2015

(51) Int. Cl. G06Q 30/02; G06N 7/00; H04L 29/08

(52) U.S. Cl. CPC G06Q 30/0244; H04L 67/306; G06N 7/005

(57) ABSTRACT

In a processing system for facilitating on-line advertising or marketer engagement on physical user devices, a device graph specifies confidence metrics for pairs of a plurality of related devices. Specific stable user identifiers are propagated from a first set of devices to a second set of devices having unstable user identifiers based on the confidence metrics. Each device in the second set of devices are designated with a single one of the stable user identifiers that have been propagated to such device based on the confidence metric or combination of confidence metrics that are associated with such single stable user identifier as compared to other confidence metrics associated with other ones of any stable user identifiers that have been propagated to such device.

### TECHNICAL FIELD OF THE INVENTION

The present invention relates to on-line advertising, and more specifically to identifying, targeting, and analyzing user data across multiple devices.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible given one or more budget restrictions. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

Advertisers may prefer to target a particular group of users when presenting an advertisement as part of an advertising campaign. Additionally, advertisers may be faced with a very large number of different groups of users. Advertisers and their agents are continually seeking ways to improve techniques for efficiently and reliably identifying, targeting, and analyzing users and associated user data.

### SUMMARY OF THE INVENTION

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one embodiment, a method for facilitating on-line advertising or marketer engagement over a computer network is disclosed. In a processing system for facilitating on-line advertising or marketer engagement on physical user devices, a device graph that specifies a plurality of confidence metrics for pairs of a plurality of devices having a same user or a closely related set of users is obtained, and a first set of the devices are associated with stable user identifiers that are designated as stable and a second set of devices are associated with unstable user identifiers that are designated as unstable. Specific ones of the stable user identifiers are propagated from the first set of devices to the second set of devices based on the confidence metrics, and each propagated stable user identifier is also propagated in association with the confidence metric of the pair of devices between which such stable user identifier is being propagated. Each device in at least a portion of the second set of devices is designated with a single one of any stable user identifiers that have been propagated to such device based on the confidence metric or combination of confidence metrics that are associated with such single stable user identifier, as compared to other confidence metrics associated with other ones of any stable user identifiers that have been propagated to such device.

In a specific implementation, propagating is performed in a plurality of cycles until a steady state is reached. In further aspect, the steady state is reached when an amount of change between a current cycle and previous cycle is less than a predefined amount. In another aspect, the label propagating is performed by a label propagation algorithm. In yet another aspect, each single stable user identifier that is designated for each device has an associated highest confidence metric total, and each confidence metric is a probability value for the associated pair of devices being a same user or a closely related set of users. In a further embodiment, at least one of the single stable user identifiers that is designated for a particular device is designated based on adding two or more confidence metrics associated with a particular stable user identifier that has been propagated to such particular device.

In an alternative embodiment, the propagating is triggered by an online advertising event. In another example, for a particular stable user identifier, user profile data associated with the devices that are associated with the particular stable user identifier are merged to form merged user profile data. In a further aspect, only portions of user profile data that are associated with access rights that allow merging are merged together. In yet a further aspect, user profile data for each device associated with the particular stable user identifier is separately maintained. In a further aspect, merging is triggered by an online advertising event that pertains to at least one of the devices associated with the particular stable user identifier.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1A is a diagrammatic representation of the use of multiple devices by related users across one or more computer networks.

FIG. 1B is a diagrammatic representation of typical objects that can be associated with a human user.

FIG. 2A illustrates a representation of a first device graph representing relationships between users of a plurality of different devices D1˜135.

FIG. 2B illustrates an updated second device graph, which includes a change in the relationships between devices D1˜D5.

FIG. 3A is a device graph portion having related devices that are associated with known and unknown user identifiers.

FIG. 3B shows the result of initiating label propagation on the device graph of FIG. 3A in accordance with a specific implementation of the present invention.

FIG. 3C represents the second propagation results for the device graph of FIG. 3A in accordance with one embodiment of the present invention.

FIG. 3D represents the final user designation results for the device graph of FIG. 3A after two label propagation steps in accordance with one embodiment.

FIG. 4A is a flowchart illustrating a procedure for propagating known or stable user identifier labels of devices to related devices having unknown or unstable user identifiers in accordance with one embodiment of the present invention.

FIG. 4B is a flow chart illustrating a procedure for managing user data in accordance with a specific implementation of the present invention.

FIG. 5A is a table that represents user profile data, as well as activity data, for a plurality of devices.

FIG. 5B is a representation of a unique user in accordance with one example.

FIG. 5C is a representation of a device's data in accordance with one specific implementation of the present invention.

FIG. 6A is a table that illustrates the results of a user data merging process in accordance with one embodiment of the present invention.

FIG. 6B is a table for maintaining separate user profiles for related devices in accordance with a specific embodiment of the present invention.

FIG. 7 illustrates an example of a system for executing label propagation or user data merging queries, configured in accordance with one or more embodiments.

FIG. 8 illustrates an example of a server, configured in accordance with one or more embodiments.

### DETAILED DESCRIPTION OF THE SPECIFIC EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

The same user or household may anonymously use multiple devices. For example, a particular user may login to a desktop computer and then use a mobile device without a same login. In another example, a particular household of users may use multiple browsers and applications on multiple devices with different or no login identities. Such disparate device use may make it difficult for an advertiser to recognize individual user activity on different devices as the same user or as belonging to the same household. If a particular user does not log in with a single identity when she uses her different devices, any user profile data or on-line activity data that is associated with each of her individual devices are not initially associated or aggregated together across all her devices. Thus, it may also be difficult to target a user or closely related group of users across multiple devices, especially when personal login information is missing or only sometimes associated with some of the related devices.

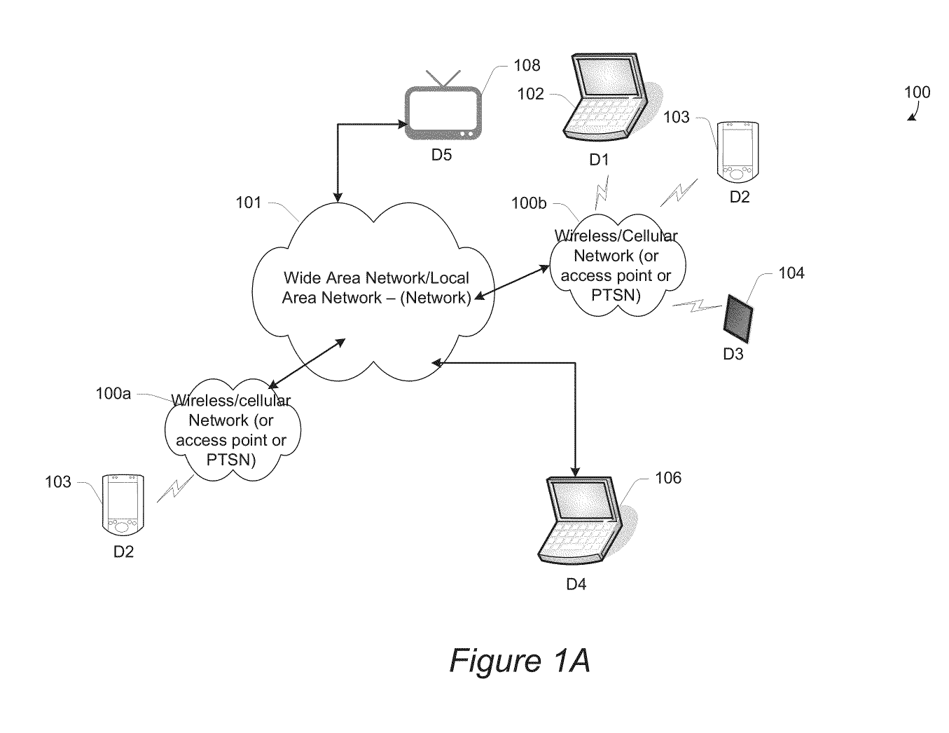

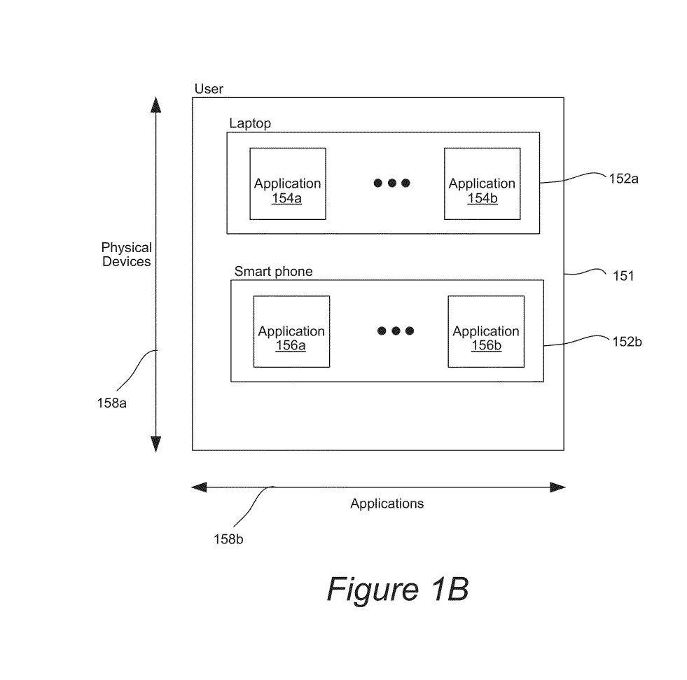

FIG. 1A is a diagrammatic representation of on-line use of multiple devices by subsets of related users across one or more computer networks. For instance, devices D1 (102) and D2 (103) may belong to a same user, while devices D3 (104), D4 (106), and D5 (108) may belong to a same household of users. A user or household of users may use these devices through any number and type of devices and computer networks, such as through a wireless or cellular network (or a plain telephone system network or PTSN) 100a or 100b and one or more wide area (WAN) and local area networks (LAN) networks 101. A user may also use a device via a Bluetooth connection to a computer that is connected to a network. There are any number and type of device and network configurations through which a device may be used by one or more users.

To further complicate usage, a single user can use multiple browsers on a desktop (e.g., from work and from home), multiple browsers on tablets, or multiple apps on mobile phone or tablet. FIG. 1B is a diagrammatic representation of typical objects that can be associated with a human user. As shown, a particular user can be associated with various user objects 151 that are configured to allow user on-line interactions. Example user objects 151 include physical devices, such as a laptop 152a and a smart phone 152b. Each physical device can also be associated with any suitable number and types of software objects or applications, such as browser applications. For instance, laptop 152a has applications 154a and 154b, while smart phone 152b has applications 156a and 156b. In general, a software object or application is configured to allow the user to interact through the associated physical device with various on-line content, services, or applications. Additionally, a user may have multiple active sessions on each type of software object or application.

In general, statistical techniques can be used to analyze the on-line activity and user profile data of various devices and generate a device graph that associates various sets of devices and their one or more users together. Devices that are described herein may include any number and types of physical and/or virtual devices, such as smartphones or other mobile devices including browsers and/or apps, desktop or laptop computer including browsers, interactive television systems including browsers and/or apps, tablets, smartwatches, wearable devices, etc. The term “device” is used herein to refer to the physical device itself or the software module (e.g., app or browser software) through which such physical device communicates with and identified by software and/or hardware objects on other devices or servers via a computer network.

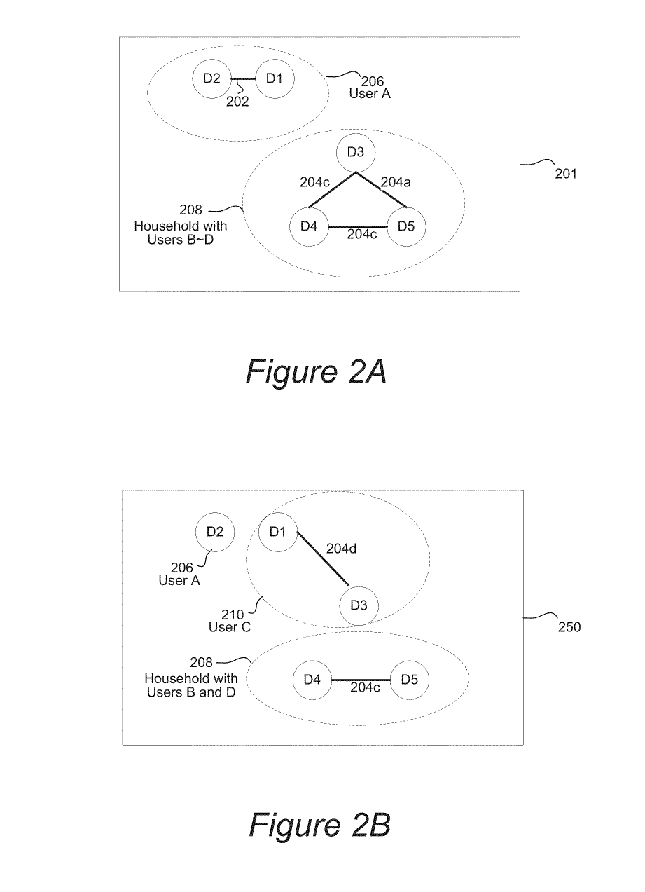

FIG. 2A illustrates a representation of a first device graph 201 representing relationships between users of different devices D1˜D5. As shown, a relationship link 202 indicates that devices D1 and D2 are related, while, links 204a, 204b, and 204c illustrate that devices D3, D4, and D5 are related to each other. For example, a single user 206 (User A) may own and use both a desktop computer D1 and a smartphone device D2. In another relationship example, a household of users 208, which includes a dad (User B) and two daughters (Users C and D), may share a laptop computer D3, a tablet computer D4, and an interactive television system D5.

The relationships between devices and their users may change over time. FIG. 2B illustrates an updated second device graph 250, which includes a change in the relationship of the devices D1˜D5 as compared to the relationships of FIG. 2A. As shown, there is a new relationship link 204d between devices D1 and D3 and no longer a relationship between devices D1 and D2. For instance, a daughter User C (210) has left household (208) with laptop computer D3 and perhaps purchased the desktop computer D1 from User A (206). As a result, device D2 (of User A) is no longer associated with any other devices since user A (206) now only owns the one device D2. Devices D1 and D3 (of User C) are associated through link 204d, and devices D4 and D5 (of Household 208 with Users B and D) are associated through link 204c.

The associations between devices/users may also be associated with a probability of relatedness. For instance, link 204d of FIG. 2B may be associated with a probability of 0.6, which indicates that devices D1 and D3 have a 0.6 probability of being devices that belong to related users, for example, in the form of a same user or household of users using different devices.

In certain embodiments, it may be feasible to aggregate at least a portion of the user profile and activity data of related users together for advertisement targeting as described further below. Although the same user or household can utilize different applications, browsers, and devices, the same user can be anonymously identified by multiple identifiers and a device graph relates particular identifiers/devices, it can be difficult to know which user or device identifiers are actually related and don't just look alike. Even given a device graph, it may still be difficult to determine which user profile and/or activity data to aggregate together from which different related devices (which can correspond to different physical or application/browser devices). For example, while some devices may be associated with a stable or reliable user identifier, other devices may not have a stable user identifier or may not be associated with any user identifier.

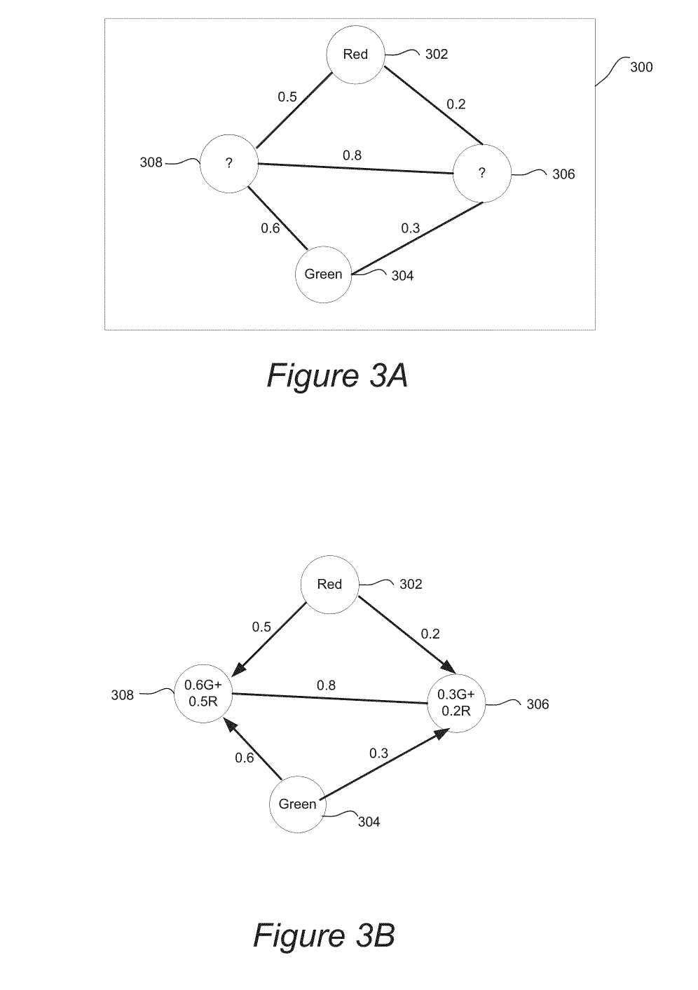

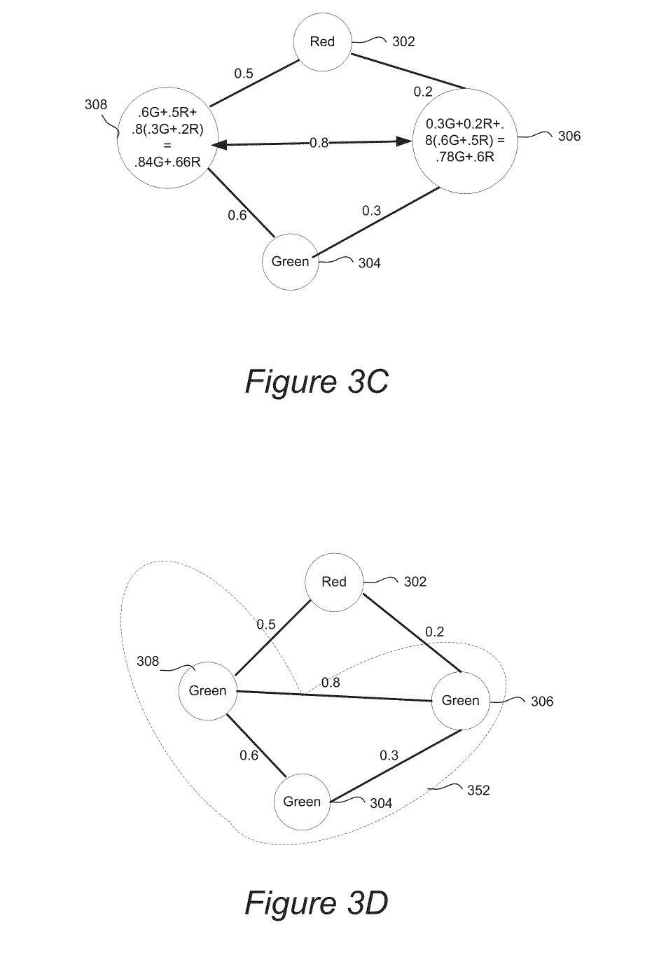

FIG. 3A is a device graph portion 300 having related devices that are associated with known and unknown user identifiers. In this example, colors represent “known” or stable anonymous user identifiers, such as stable cookies. As shown, device 304 is associated with a known “green” identifier, and device 302 is associated with a “red” identifier. In contrast, devices 306 and 308 do not have known identifiers. For example, the known green and red identifiers can correspond to stable user or device identifiers that have been designated as stable by an expert user. In other embodiments, certain user or device information may be distinguished as being more reliable than other information. For example, hardware identifiers or login identifiers can be considered more reliable and “stable” than cookies.

These techniques would not affect the privacy preferences of the user. A user who has opted out of using a cookie mechanism will not be tracked and, hence, his/her profile will not be merged. Furthermore, these techniques could be used to improve the privacy protection of a user by opting him/her out of all of his/her connected devices, if he/she so chooses.

In other embodiments, a user identifier may be defined as stable, reliable, or known based on one or more metrics. For instance, a user ID may be defined as stable when it has persisted longer than a predefined time period, been associated with a predefined amount of user activity, is associated with a stable ID like a phone subscriber ID, etc. In a specific implementation, a user identifier is defined as stable when it has existed for more than an hour or, more specifically, more than one hour and has been observed to have some online activity. In contrast, if a device is associated with a user identifier that has existed less than such predefined time period or with less than a certain amount of user activity, such device is defined as having an unknown or unreliably identified user.

In another example, if a user identifier is associated with an amount of activity that is above a predefined amount, such user identifier can be defined as known or stable. This predefined amount may be an absolute threshold or may be dynamically based on the average or mean amount of activity and deviation amounts.

As shown, the device graph 300 also relates devices via relationship probabilities. As shown, unknown device 308 has a probability of 0.5 of being related to known red device 302, a probability of 0.8 of being related to unknown device 306, and a probability of 0.6 of being related to known green device 304. Similarly, unknown device 306 has a probability of 0.3 of being related to known green device 304 and probability of 0.2 of being related to known red device 302.

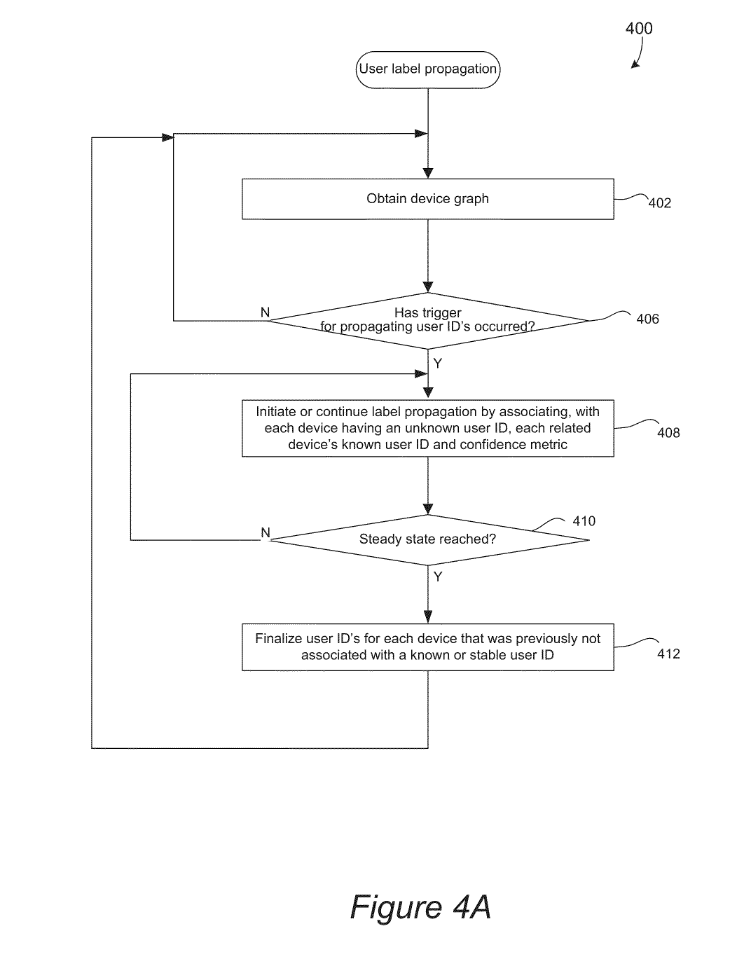

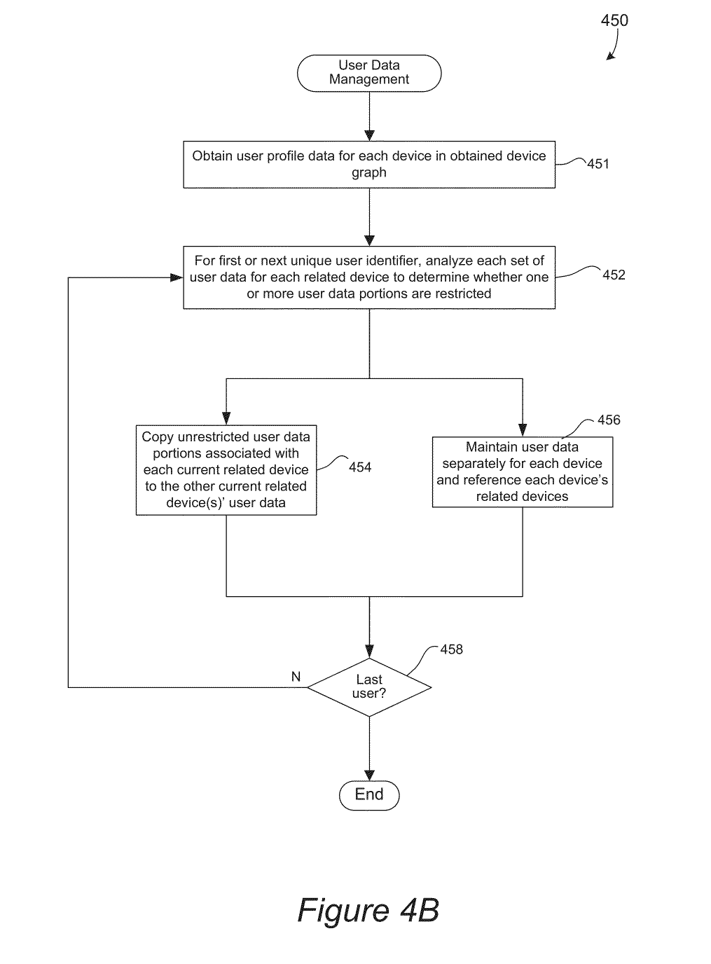

Certain embodiments of the present invention provide techniques for grouping sets of unknown (or unstable) devices together under particular known or stable user identifiers. Any suitable technique may be used to anonymously associate known or stable user identifiers with devices that have unknown or unstable user identifiers. FIG. 3B-3D and FIG. 4A are diagrammatic representations and a flowchart, respectively, illustrating a procedure 400 for propagating known or stable user identifier labels of devices to related devices having unknown or unstable user identifiers in accordance with one embodiment of the present invention.

A device graph may initially be obtained in operation 402. A device graph that specifies relationships between devices (including apps, browsers, or the like) as belonging to the same user or a closely related set of users may be obtained in any suitable manner. The data that is used to generate a device graph may include identifiers for each specific device and/or user of such device. For example, when a user requests a page through a device's browser or app, the page request will generally contain a unique device identifier and sometimes a device type identifier. This device identifier (and device type) may also be associated over time with various user data that indicates various types of user on-line activity, user location, etc. This user data can be analyzed to make inferences to generate any number and type of device graphs. For example, if several devices use the same IP address, such as provided for a home network, these devices may be related to an aggregated user, such as a household. If one of these devices consistently moves to a same work location at about the same time of day and then another desktop or laptop device is used at the same location, the desktop/laptop device may be inferred to be related to the mobile device and its same user.

In general, a statistical approach to determining which devices are likely related to a same person or closely related group of people may be used to generate a device graph. Additionally, this device graph may be supplemented by known relatedness information, such as user login from various devices. For example, if a user logs in with a same username on two different devices, it may be inferred that the two devices are being used by the same person, even when some user activity on the two devices does not include a login session.

Although the following description refers to a single device graph, it is contemplated that multiple device graphs can be utilized for various embodiments of the present invention. When multiple device graphs are used, they may be combined or averaged together, for example, to combine relationships and confidence scores. Inconsistencies may be filtered out. For instance, relationships that are present in a single device graph and not present in other graphs can be filtered out and optionally based on a predefined confidence threshold.

It may be determined whether a trigger for propagating user labels has occurred in operation 406. A trigger may take any suitable form. In a specific embodiment, user ID propagation can occur in real-time each time a bid request is received. In another off-line example, a trigger may be in the form of expiration of a timer. User ID propagation may also be triggered each time a new piece of user data is generated or updated or after a particular amount of new user data is collected, obtained, or received. Other trigger factors may include reaching a threshold number of devices with new user data, time lapse since last collected data or interaction analysis, etc.

If a trigger has not occurred, an updated device graph may continue to be obtained based on updated user data, by way of example. After a trigger occurs, label propagation may be initiated in operation 408. Based on a received device graph, each device with an unknown or unstable user ID may be analyzed for label propagation. In general, any suitable representation and process may be used to propagate labels from devices with known or stable user identifiers to devices with unknown or unstable user identifiers.

In a device graph, each relationship between devices may be associated with one or more confidence metrics such as a probability that the devices are related, and these relatedness probabilities can be used as probabilities that known user identifiers can be applied to related devices with unknown user identifiers. In a Markoff chain, these relatedness values can pertain to cycles. In FIG. 3A, the relationship between red device 302 and unknown device 306 is associated with a confidence or probability of relatedness value of 0.2. Likewise, the relatedness metric for green device 304 and unknown device 306 is 0.3. There is also a relatedness metric of 0.5 between unknown device 308 and the red device 302 and a relatedness metric of 0.6 between the unknown device 308 and green device 304.

For each device having an unknown user ID, the known user ID and confidence metric of each related device of such device can be associated with such device in operation 408 so as to perform the initial step of label propagation. The result of initiation of label propagation on the device graph of FIG. 3A is illustrated in FIG. 3B in accordance with a specific implementation of the present invention. As shown, device 308, which had a previously unknown user identifier, is now associated with a confidence metric of 0.6 for green identifier (0.6G) and confidence metric 0.5 for a red identifier (0.5R) to form propagated labels 0.6G and 0.5R, while device 306 is associated with propagated labels 0.3G and 0.2R.

It may then be determined whether a steady state has been reached in operation 410. If steady state has not been reached, a second or next propagation may occur. The example of FIG. 3B illustrates only a single label change for devices 308 and 306. FIG. 3C represents second propagation results for the device graph of FIG. 3A in accordance with one embodiment of the present invention. During this second propagation cycle, the labels 0.6G and 0.5R that were previously propagated to device 308 can also be propagated to device 306. The labels 0.6G and 0.5R are also propagated together with the confidence value 0.8 (for relatedness between devices 308 and 306) to device 306. Likewise, the labels 0.3G and 0.2R that were previously propagated to device 306 can be propagated to device 308 along with confidence metric of 0.8.

For each device, the second set of propagated labels can then be combined with the initial set of propagated labels. For instance, the relatedness values for each propagated device label (e.g., red or green) can be added together. Thus, device 308 now is associated with the green label having a confidence metric of 0.84 and is also associated with the red label having a confidence metric of 0.66. Likewise, device 306 is associated with the green label having a confidence metric of 0.78 and is also associated with the red label having confidence metric of 0.6.

In general, label propagation may be performed until a steady stage is reached or a stop event occurs. A steady state may be defined in any suitable manner. By way of examples, a steady state may be defined when the resulting propagated labels remain unchanged or below a predefined degree of change from one propagation step to the next, the number or percentage of devices that change their labels being below a predefined amount or percentage, etc. The example of FIG. 3C also represents the steady state label propagation result for the illustrated device graph of FIG. 3A. As shown, a label has been propagated for each related device of each device with no known or stable user identifier.

After steady state is reached, user identifiers may then be finalized (or designated) for each device that was previously not associated with a known or stable user ID in operation 412. FIG. 3D represents the final user designation results for the device graph of FIG. 3A after two label propagation steps in accordance with one embodiment. The final user ID for each device may be determined by which user ID has the highest combined probability for such device. For device 308, green has a probability of 0.84 and red has a probability of only 0.66 (as shown in FIG. 3C). For device 306, green has a probability of 0.78 and red has a probability of 0.6 (as shown in FIG. 3C). Thus, the green user ID is assigned for device 308 and 306 (as shown in FIG. 3D).

The finalization process may also consider probability thresholds. For instance, a device may remain unlabeled if it does not have an associated propagated user ID with a probability above a predetermined threshold. The threshold may be selected based on a personal preference as to the tradeoffs between accuracy and the amount of data spread/referenced across devices. For example, a confidence threshold of 5% would result in a huge data spread and low accuracy, while a confidence threshold of 100% would result in a small spread that is very accurate.

User data may also be received and managed with respect to devices having stable, unstable, or newly propagated user identifiers. FIG. 4B is a flow chart illustrating a procedure 450 for managing user data in accordance with a specific implementation of the present invention. User profile data may be obtained for each device in an obtained device graph in operation 451. In general, user profile data may be continually obtained for devices in the device graph as well as other devices that are not in the device graph. User profile data may be obtained for a device graph that has been recently generated, updated, or an older version. User profile data may be obtained from a variety of data sources, such as 1^{st} party sources (advertisers) or other 3^{rd} party sources.

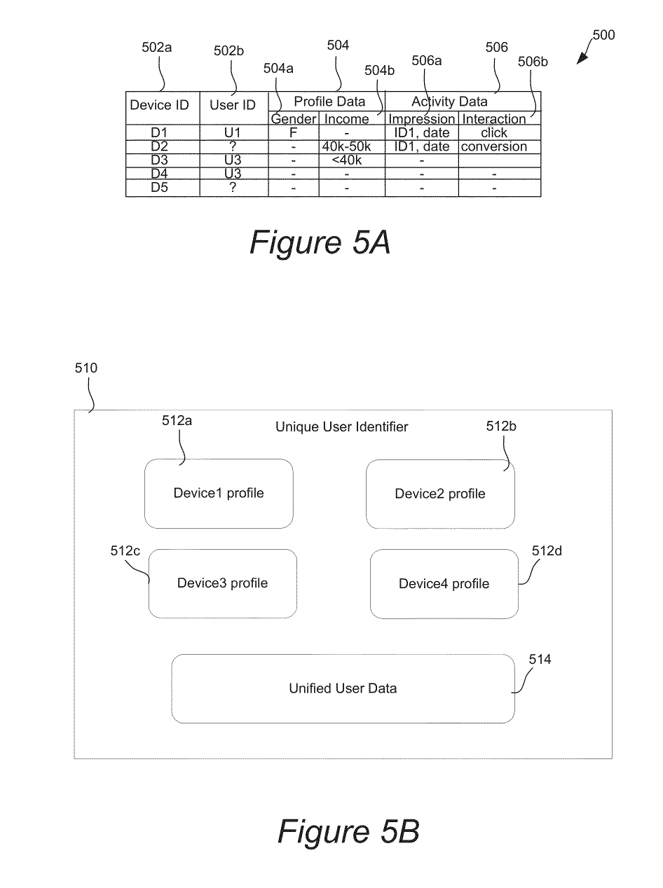

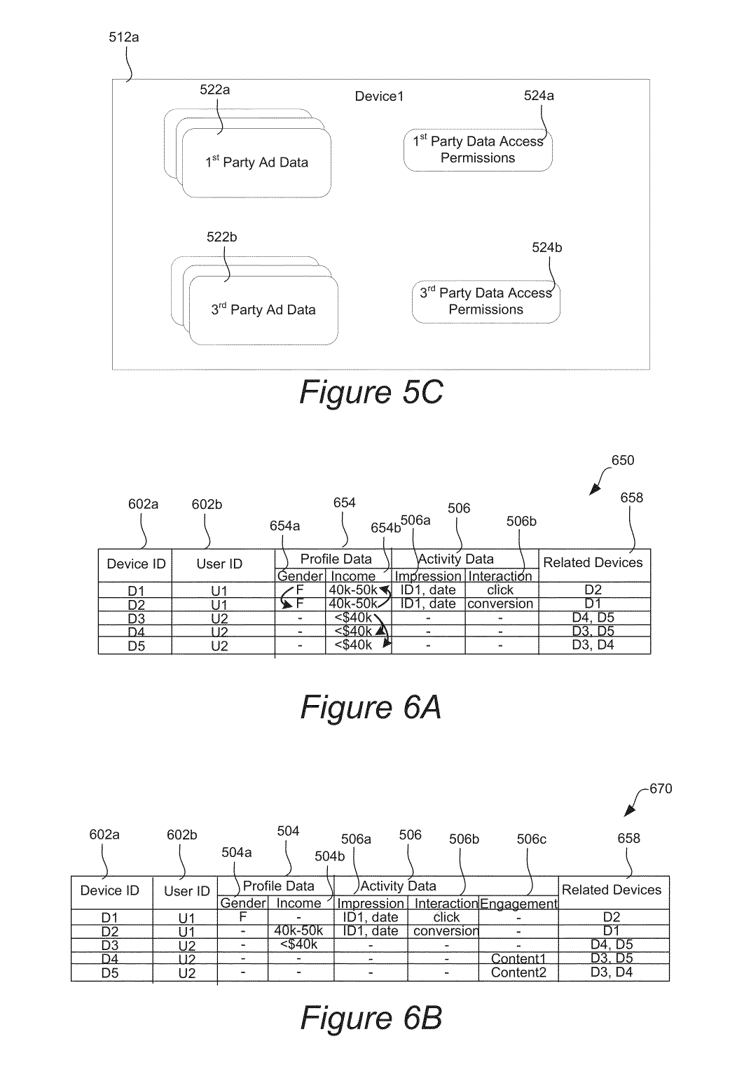

FIG. 5A is a table 500 that represents user profile data, as well as activity data, for a plurality of devices. As shown, the table 500 includes a column for a device identifier 502a and user identifier 502b. The device identifier 502a may include a unique device identifier and a device type, while the user identifier may be an anonymized and unique user identifier that is generated by the device, a service, advertiser, or a bid management or demand side platform (DSP). For example, the user ID may be a cookie ID. Some of the devices (e.g., D1, D3, and D4), may be associated with a stable or known user ID (e.g., U1 and U3), while other devices (e.g., D2 and U5) may be associated with an unstable or unknown user ID, which are represented as “?” in this FIG. 5A.

The table 500 may also include any number of user profile columns 504, e.g., gender 504a and income 504b. As shown, a device D1 is associated with a gender that is specified as female (F), while the other devices D2-D5 are not associated with a specified gender. Similarly, device D2 pertains to a user income value of $40 k-50 k, and device D3 pertains to a user income of less than $40 k. Although only two user characteristic types are illustrated, each device may be associated with any number and type of user profile characteristics.

Each device may also be associated with its own activity data 506, including impression data 506a (e.g., impression identifier and time that the impression was served to the device) and user activity indicator 506b that specifies various interactions that the user had with respect to the particular impression and a time at which such interaction occurred. Interactions may include clicks, downloads, site visits, mouse overs, video/audio play (or pause, forward, rewind, etc.), conversions, an engagement heatmap, view time, view based actions, etc. A heatmap may illustrate a quantitative level of activity with respect to an impression or other content. Other activity data, besides data pertaining to impressions, relates to marketing engagement activity or data 506c. For example, marketing engagement may include an advertiser providing particular content on a product site so as to engage particular audience segments in various activities (such as publications, surveys, discussions, etc.) As the device receives more impressions or engages in various marketing activities or content, multiple entries may be generated for the multiple impressions or engagements.

Although the illustrated device data table 500 shows a single entry for each device that includes user profile data and impression data for a single impression, other data representations are contemplated. For example, one or more device entries may indicate one or more user profile characteristics. Likewise, one or more device entries may indicate one or more impression data sets. That is, each impression's data may be listed in a separate entry or listed together in a single device entry. The user profile data entries may also be separated from the impression data entries.

Label propagation may have resulted in a unique user identifier being associated with multiple user or device profiles. However, it may be desirable to merge user or device profiles for unique users for various applications. However, certain user data may be restricted and cannot be copied or merged across related devices. For instance, certain user data may originate from a third party who places legal or privacy restrictions on such certain user data. That is, certain user data may include specifications regarding legal and/or privacy restrictions. More specifically, the restrictions may inhibit or restrict making copies of the data, distributing the data, distributing the data to certain destinations or users, etc. In order to meet user data restrictions, certain embodiments of the present invention may include techniques for keeping restricted user profile and activity of related devices separate, while aggregating unrestricted user profile and activity data of related devices.

Referring back to FIG. 4B, each set of user data for each related device for each first unique user identifier may be analyzed to determine whether one or more user data portions are restricted in operation 452. For instance, it may be determined whether particular user profile data cannot be shared or aggregated across devices.

Any suitable type of data representation may be utilized to maintain user data restrictions while merging other unrestricted user data. Each set of related devices with the same finalized user ID can be said to form a sub-graph that represents a unique user. FIG. 5B is a representation of unique user in accordance with this example embodiment. As shown, unique user identifier 510 is associated with separate device profiles 512a, 512b, 512c, and 512d.

Each set of device data may pertain to accessible data portions that have different levels of access rights. FIG. 5C is a representation of data for device 512a of FIG. 5B. As shown, device 512a may include 1^{st} party data 522a and 3^{rd} party ad data 522b. Both the 1^{st} and 3^{rd} party ad data may include any suitable type of user profile and activity data, for example, that can be used as user advertisement data. The device 512a may also be associated with 1^{st} party data access permissions 524a and 3^{rd} party access permissions 524b, which can specify unrestricted and/or restricted access for both the 1^{st} and 3^{rd} party ad data 522a and 522b.

In general, access permissions may specify that the entire associated set of data can or cannot be shared across devices. In the illustrated example of FIG. 5C, the 1^{st} party data access permissions 524a may specify that the 1^{st} party ad data can be distributed or shared across devices. In contrast, the 3^{rd} party data access permissions 524a may specify that the 3^{rd} party ad data cannot be distributed or shared across devices. By way of specific example, 3^{rd} party data access permission 524b may specify that the entire set of accessible 3^{rd} party data is read-only. Examples of access permissions may include access control lists (ACL's), which can be specified by various methods The access permissions may alternatively specify that certain portions of the associated ad data are sharable across devices while other data portions are not sharable across devices.

After access permissions are determined for the current unique user, a user data merging process may be performed for the unrestricted user data portions that are allowed to be aggregated across devices. As shown, unrestricted user data portions that are associated with each current related device may be copied to the other current related device(s)′ user data in operation 454. That is, the unrestricted user data from each related device are merged together for the current unique user.

FIG. 6A is a table 650 that illustrates the results of a user data merging process in accordance with one embodiment of the present invention. After the process for propagating user identifiers or labels, specific user identifiers (602b) are associated with one or more device identifiers (602a). For example, user identifier U1 is associated with both related devices D1 and D2. Likewise, user identifier U2 is associated with devices D3, D4, and D5.

For each unique user identifier, the unrestricted user data portions from the different related devices can be merged together. FIG. 5A represents the user data prior to being merged, while FIG. 6A represents the user data after merging. In this example, the user data specifying a female gender for device D1 (FIG. 5A) is copied to the user data for device D2 (FIG. 6A) since devices D1 and D2 are related and have a same unique user identifier U1. Likewise, the user data that specifies an income of $40 k-50 k is copied from device D2 to device D1. Each device in the current related devices D1 and D2 may be associated with its other related device D2 and D1 (column 658), respectively. Activity data may also be merged together (not shown).

Referring back to FIG. 4B, the user data of the current unique user may also be maintained separately for each device in operation 456, as opposed to certain user data portions that are merged together in operation 454. The related devices of each device may also be referenced for such device. FIG. 6B is a table 670 for maintaining separate user profiles for related devices in accordance with a specific embodiment of the present invention. As shown, each device maintains its own set of user data. However, each device is also associated with its related devices in column 658.

Thus, user data for each device may stay separate, and a particular unique user and associated user data can change at any frequency without disturbing the data sets in these multiple device profiles. The user data for each device of a unique user may later be traversed to find user data specific to a particular device for a unique user (e.g., cost attribution) as further described below. Keeping the devices and their data attributes separate allows for a much more granular understanding of user behavior during data analysis.

Referring back to FIG. 4B, it may be determined whether there are any more unique users in operation 458. If the processed unique user is the last unique user to be processed, the procedure may end. If the processed unique user is not the last user, the process may be repeated so that the user data for a next unique user is analyzed. For the next user U2, for example, user income <$40 k for D3 (FIG. 5A) may be copied to the other related devices D4 and D5. Each device in the current set of related devices D3-D4 may also be associated with its other related devices. For example, device D3 is associated with devices D4 and D5, while device D4 is associated with related devices D3 and D5. Likewise, device D5 is associated with related devices D3 and D4. This process for merging unrestricted user data may be repeated for each unique user. Alternatively, the unrestricted user data for each single unique user may be merged only for a set of devices that are related to the current event, such as a bid request, pixel fire, etc. as described further below.

The merged user data (FIG. 6A) or separate device user data (FIG. 6B) may be obtained for each updated device graph. Any time a new device graph and updated user data are generated or updated, the previous device graph and updated user data may be maintained and stored so as to allow analysis of how the device relationships and corresponding user data have changed over time.

The separately maintained and/or merged user data may be used to anonymously target and analyze user profile and on-line behavior data across multiple devices that are used by the same user or a set of closely related users, such as a household, to facilitate on-line targeted advertising. For example, a campaign may be set up and executed based on merged user profiles from their related devices. Additionally, particular audience segments may be targeted across devices or a sequence of devices based on separate user data for each device. Various combinations or aspects of the aggregated or separate device profile data may also be analyzed and reported to determine how to optimize advertisement campaigns. Other uses of aggregated or separate user device profiles may also include marketing engagement for particular merged profiles across devices.

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers very quickly determine a bid value for each bid request that is sent from a seller of an impression. For instance, a DSP may determine a bid value in milliseconds for close to a million bids per second based on information provided with each bid request that is sent from a publisher, for example, via an RTB exchange.

In some instances, a DSP may assist the advertiser in configuring the advertising campaign. According to various embodiments, the advertiser may designate an initial target audience. The DSP may recommend modifications to the initial target audience to provide improved advertising campaign performance.

In some implementations, a target audience for an advertising campaign may be selected by designating one or more data sources and/or data categories. Each data source may be provided by a data service provider. The data service provider may provide data for determining whether a potential advertising audience member associated with an incoming advertising opportunity bid request falls within a designated category.

For example, a data service provider may provide a data source that distinguishes between many advertising opportunity bid requests based on geographic region within the United States. Categories within this data source may include states, major cities, zip codes, and direct marketing areas (DMAs) within the United States. As another example, a data service provider may provide a data source that distinguishes between many advertising opportunity bid requests based on estimated yearly income. Categories within this data source may include income ranges such as “$15,000-$30,000” and “$30,000-$45,000.” According to various embodiments, data categories may distinguish between potential advertising audience members based on any of potentially many different factors. These factors may include, but are not limited to: age, sex, race, income, purchasing patterns, purchasing intent, personal interests, education, profession, consumer preferences, political affiliations, and geographic region.

According to various embodiments, a data segment may be used to select incoming advertising opportunity bid requests for bid placement. For instance, an advertising opportunity bid request may be associated with an individual identified as likely being female and 32 years of age.

One or more device constraints, which may include specifications for cross-device sequencing, may also be provided for each campaign package. In certain embodiments, one or more device constraints may be designated by specifying a particular target device, such as a mobile or desktop/laptop computer, for displaying a selected advertisement creative. An advertiser may specify a sequence of devices for consecutively displaying impressions. For example, the sequence may include a particular creative being displayed first on a user's mobile and then on a user's desktop computer. A cross-device frequency cap for each campaign package may also be obtained. For instance, the advertiser can specify how many times a user is shown a particular creative, regardless of which device the creative is displayed.

A DSP may also be configured to respond to bid requests based on the campaign constraints that are set up by advertisers. Each received bid request may include a user/device ID and media content ID (e.g., u and w). User profile and/or media content profile data may also be provided by the publisher with the bid request. User profile and media content profile data that pertains to the bid request data may be retrieved. For example, this retrieval process may be performed to obtain user or media content data that was not provided in the bid request if a user ID or device ID is provided in the bid request and user and media content profile data is retrievable. For instance, the DSP retrieves user and media content profiles (and/or other type of data) that were previously stored and mapped to the user ID or device ID provided in the bid request. For instance, user profile data that is associated with devices that are related to the current device ID may also be retrieved from either merged or separate user data for the related devices. However, either profile may also be empty if u or w is new to DSP or if u or w is not provided in the bid request sent to DSP.

The user profile of user u may include any characteristics that were, are, or can be associated with the particular user u. To protect a user's privacy, user profile data may be stored with an anonymized type of user identifier, such as an arbitrary or randomized identity, rather than the user's actual name, specific residency, or any other type of user identifying information. Examples of user profile data for the particular anonymized user u may include descriptive data, such as personal or professional interests, employment status, home ownership, knowledge of languages, age, education level, gender, race and/or ethnicity, income, marital status, religion, size of family, field of expertise, residential location (country, state, DMA, etc.), travel location, or predictive data, such as likelihood to consume content or perform an activity, such as clicking on an ad, visiting a page or purchasing a product or service, in the near future, etc.

The user profile data may also include browsing history information, such as pages visited, amount of time per page viewing, links clicked on, searches performed, actions or interactions taken, amount and type of purchases made, etc. The browsing history information may be expressed using any suitable one or more metrics, such as count, absolute or relative value, average, mean, frequency, time duration, etc. The user profile of user u may also include contextual data, such as where the user is currently located, the weather at such location, current events at such location, etc. For instance, the ad request may include a GPS (global positioning satellite) value or access point location for the user u, and other contextual data may be scraped from other databases, such as a weather, time of day, or entertainment event web site for such location. The media content profile may identify various characteristics of the web page or ad space or ad placement that is available for purchase, such as one or more content category, ad placement position (e.g., top, side, or bottom of page), ad type (e.g., banner, video, pop-up), brand safety (e.g., absence of alcohol, violence, drugs, competitive brands), page quality (e.g., absence of cluttering images, prominent display of the ad), etc.

If user profile data was previously merged from related devices, user profile data for the current unique user ID, which includes user profile data from related devices, may then be retrieved. If there is no merged data for the particular unique user ID, label propagation and merging process may be performed as described above. The user profile associated with the current user ID and/or device ID may also be obtained from the separate device profiles as described above. Merged data or separate data may be selected based on the access rights for such data. Alternatively or additionally, user profile data may be retrieved by collecting user profile data that is associated with the different related devices for the particular user/device u associated with the bid request. If bid request specifies a user/device identifier D, user profile data that specifies a female gender may be retrieved from the entry for device D1 for the example in FIG. 6B. The related device D2 may also be obtained from such D1 entry, and then the user profile data that specifies an income of $40 k-50 k may also be retrieved from the related device D2's entry so that the current bid request is associated with a female user having an income of $40 k-50 k.

In general, the DSP may run various advertisement optimization algorithms to find the best ad for u and w of the bid request. This advertisement optimization may include optimizing for the ads' campaign goals while satisfying constraints. The DSP may work with a variety of advertisers who utilize different campaign types. The campaigns may utilize performance goals for each package or segment of users or media content. That is, different packages may have a different set of constraints and different performance metric goals. A performance metric may include a cost-per-click (CPC), cost-per-action (CPA), click-through-rate (CTR), or action-rate (AR) although CPA is used herein to refer to any type of performance metric or goal. The packages of a particular campaign may have the same ad or a custom ad for the particular segment of users or media content.

In some implementations, techniques and mechanisms may be described herein as solving “optimization” problems or as “optimizing” one or more parameters. It should be noted that the term optimize does not imply that the solution determined or parameter selected is necessarily the best according to any particular metric. For instance, some optimization problems are computationally intense, and computing the best solution may be impractical. Accordingly, optimization may involve the selection of a suitable parameter value or a suitably accurate solution. In some instances, the suitability of a parameter value or solution may be strategically determined based on various factors such as one or more computing capabilities, problem characteristics, and/or time constraints.

The DSP may filter ads based on each ad's associated user profile constraints, device constraints, including cross-device sequencing, and frequency caps. For instance, one particular ad constraint specifies that this particular ad only applies to users are male. Accordingly, if the bid request is associated with a user u, who is female, this particular ad is filtered out from the candidate ads. In contrast, if another ad has an associated constraint specifying users are female and having an income of $40 k-50 k, this other ad is not filtered out for the ad request for an Oregon user and such other ad is deemed to be a candidate ad for further bid processing.

Each time a particular ad (or set of ads) was shown to a particular user/device or across a set of related devices, a count may have been tracked for the particular ad so that the ad can be only shown a predefined number of times in a particular time period, i.e., so as to meet the particular ad's frequency cap. For instance, if the ad's specified frequency cap is 5 ads being shown to a user per day across related devices of an aggregated user profile and the particular ad has already been shown on an aggregated user's mobile display 5 times during the day, then the particular ad is filtered from a user u who is associated with the same aggregated user profile, even if such user is currently using a related desktop computer, as opposed to the device associated with the current bid request.

Bids may then be determined for each of the filtered ads based on the ad's associated campaign parameters, including goals such as a CPA, in operations 608. For an ad having a CPA, the bid b may be computed as:

b=p(u;w;a)×CPA

where p(u; w; a) is the probability of action given u, w, the ad a, and optionally other related parameters in the bid computation context. This probability may be computed using any suitable techniques, such as a machine learning algorithm. Several example techniques are described in the paper: D. Agarwal, R. Agrawal, and R. Khanna, “Estimating rates of rare events with multiple hierarchies through scalable log-linear models”, ACM SIGKDD Conf. on Knowledge Discovery and Data Mining, 2010, which paper is incorporated herein by reference for providing a technique for determining probability of an actions, such as user conversion or other actions with respect to impressions. Probability of conversion depends on past conversion rates of particular users with respect to particular media content and location, ad placement, and context.

Of course, CPA may be replaced with a CPC or CPM value (converted to a cost per impression). At least some input for determination of this probability p is provided in the bid request itself. In the CPM example, the bid b may be set equal to the advertiser specified CPM minus the fees charged by the DSP.

The bid determination techniques described herein may also factor in the corresponding ad campaign or package budget and a specified time frame for such budget to be spent. For instance, if ad purchases for a particular campaign are underspent by more than a predefined amount, the bid amounts may be increased. Likewise, if the ad purchases are overspent by more than another predefined amount, the bid amounts may be decreased. Moreover, a campaign budget can be periodically allocated to different packages of a campaign using an algorithm. The periodic allocation can consider the spend amount and performance levels of each package for allocating more or less budget to these packages.

The best bid and its associated ad specifications may be found and sent to the ad exchange system, which sent or forwarded the bid request. For example, the DSP responds back to the bid request sender, e.g., RTB exchange, with its best bid and information on the corresponding ad, specifying how to retrieve the best bid's ad's creative content (e.g., the actual image corresponding to the ad). The RTB exchange then sends its best bid (selected from all DSP best bids) back to the bid request sender (or publisher). Out of all bids that are received by a bid exchange from all associated DSPs, the bid exchange may also send the highest bid out of the determined bids and associated ad specification to the publisher for display in the ad space.

While impressions are being served to users who are associated with merged or separate user profiles, cross-device data may be compiled for such users. Each time an impression may be served to a new or existing user on a new or existing device, impression data may be recorded in association with the particular device's user identifier, as well as the previously recorded user profile data. User interaction data may then be recorded in association with the current device's user identifier (and previously recorded impression and user profile data). The user identifier may be an existing or newly assigned user identifier for the current device. For example, if a user interacts via a particular device with the served impression (e.g., clicking on or moving a mouse over the creative, purchasing a product associated with the advertisement, etc.), data regarding such interaction type and time are recorded in association with the device's user identifier. In other examples, the recorded interaction data may include marketing engagement data for type, frequency, quantity, and time of engagement (or any other suitable engagement parameter).

It may also be determined whether a performance action has occurred, and such performance action may be recorded for a particular user ID and/or device ID. For instance, an advertiser may define a performance action as a conversion or a click with respect to the ad. Conversions may take any suitable form, such as an advertisement viewer purchasing a product, filling out a form, signing up for e-mails, and/or performing some other type of action.

If there is a performance action, the action may be attributed to only the current impression in a last touch attribution (LTA) approach or attributed to a set of impressions that were most recently served to the current device or any other devices that are related to the current device in a multi-touch attribution (MTA) by analyzing the separate user data for related devices.

The user data that is compiled for user activity on related devices may be used to determine performance metrics for any combination of user profile characteristics across one or more related devices. Performance metrics may be determined for particular audience segments, devices, device sequencing, or the like at any suitable time. For instance, it may be determined which user profiles that are merged across related device are more valuable to a particular advertiser. That is, an audience definition can be obtained and analyzed across related devices. In one example, some devices may only specify a male gender, while other related devices are associated with users who are skateboard enthusiasts. When the related device data is merged, it may be determined that users who are male and skateboarders are more valuable to an advertiser than users who are only male or only skateboarders. In another example, some devices may be associated with user data indicating interest in baby products, while other related devices may be associated with professional data indicating a high income. The merged user data in this later example may be used to promote high-end baby products to such users across one or more of their related devices.

Performance metrics may be determined at the request of an advertiser or marketing agent/system. Performance metrics may be determined by any general marketing platform, such as one or more DSP and/or DMP in cooperation with each other or with one or more 3^{rd} party systems. Although the following example implementations are described in terms of a DSP, techniques and mechanisms of certain embodiments may be implemented on any suitable type and number of marketing systems, such as DSP, DMP, a DMP that serves multiple DSP's, etc.

A DSP may also automatically determine performance metrics at predefined time intervals or after specified trigger events, such as during or after execution of a campaign, etc. In general, performance metrics may be determined for one or more audience segments, device types, or device sequences, or any combination thereof. The performance metrics may also correspond to all or a portion of the specification of a campaign or its different packages. Performance metrics may be determined for multiple packages or a single package, an expansion or reduction of one or more package's audience segments (i.e., performance metrics are calculated for a smaller or larger audience segment than is specified in a campaign package), etc. Techniques and mechanisms for optimizing audience segments by expanding or reducing audience segments of a campaign package are further described in U.S. patent application Ser. No. 14/132,293, filed 18 Dec. 2013, by Neil Shah et al., which application is incorporated herein by reference in its entirety. Similar techniques may be used to determine performance metrics for reducing or expanding audience segments, device specifications, or device sequencing specifications as specified in one or more campaign packages.

Performance metrics may be determined for various reasons, such as to optimize a campaign or provide a report. Performance metrics for different combinations of user, device, or cross-device specifications may be obtained. For example, conversion rates can be obtained for different audience segments as aggregated into a merged user data set from related devices. In one example, a conversion rate for females having an income of $40 k-50 k may be determined from conversion activity on any related device that is associated with a user profile specifying that the user is female and/or an income of $40 k-50 k. In the example of FIG. 6A, the conversion on device D2 counts as a conversion for a female having a $40 k-50 k income based on the merged profile obtained from devices D1, which is associated with a female user, and device D2, which is associated with an income of $40 k-50 k. The conversion counts for a particular audience segment across related devices can be multiplied by a return amount and then the total return amount can be compared to the advertisement investment for the particular audience segment to obtain a return on investment (ROI) amount.

Performance metrics may also be obtained for each combination of one or more device types (e.g., mobile vs. desktop/laptop) and/or each combination of device sequencing for one or more packages. In a device type example, performance metrics may be determined for a user ID (or household) who has 2 tablets and 2 mobile phones or a user ID who has at least two display type devices (e.g., desktop or laptop). In a sequencing example, ROI may be determined for a creative that is shown in a first order (mobile-->display-->mobile) and a second order (mobile-->mobile-->display). Performance metrics may be calculated for any suitable number of sequences. Performance metrics may also be obtained for each different sequence and each different audience segment combination. Performance metrics may also be obtained for different frequency caps for one or more device types, audience segments, and/or one or more impressions.

The above examples merely represent a few of the different package parameters that can be analyzed for performance. Other parameters for which a performance metric may be determined include different user profile characteristics, different ad space characteristics (e.g., top or bottom), different devices, different combinations of number and types of related devices, different publisher characteristics, etc.

Performance metrics can also be compared to each other or to one or more predefined thresholds. For instance, it may be determined which audience segment, whether such audience segment is equivalent to a current package or a sub-portion or expansion of a current package, has the most value for the advertiser. For instance, if a current package has a particular audience segment that combines particular user profile characteristics (e.g., via a Boolean expression), an audience segment that has fewer or more user profile characteristics may be determined to result in better performance than the current package.

A change in campaign specifications may also be recommended to an advertiser based on performance metrics. For example, a recommendation to add or remove a user profile characteristic from a package may be presented to the advertiser. The advertiser or DSP may also choose to bid higher for more valuable audience segments, including device types and sequencing combinations, which are obtained through aggregated profile data.

Reports may be generated based on any combination of audience parameters, such as one or more user profile characteristics, one or more particular types and number of devices, etc. If a request has been received (or this reporting option is automatic), performance metrics for each device sequence may be determined and reported based on data compiled for related device profiles (merged or separate).

Any portion of any user, ad, or publisher data that is associated with a particular device that has one or more related devices may be analyzed and used to determine and report performance metrics at any suitable time. For example, any user profile data sub-portion of the aggregated data may be analyzed separately over time. Additionally, any user profile data sub-portion can be analyzed with respect to any combination of related devices based on related devices and their merged or separate user data that is recorded over time. For instance, different user characteristics can be merged together across related devices to determine performance by users having merged characteristics.

Additionally, an average user flow to perform a particular action, such as conversion, may be determined. For instance, an average purchaser of product X may be a user who views a particular ad on her mobile device and then converts on a display device, rather than a user who views an impression only on her mobile.

Specific events may be recorded for specific devices over time and then later analyzed together so as to obtain a more complete picture of events that were performed by related devices and particular users for a predefined period of time. In other words, events associated with a set of related devices and its unique user identifier may be analyzed during a specific timeline. The user data from related devices or a unique user ID can also be broken into any useful data portions and analyzed to determine which user audience segments, devices, sequencing, frequency caps are more valuable for a particular advertising campaign or brand.

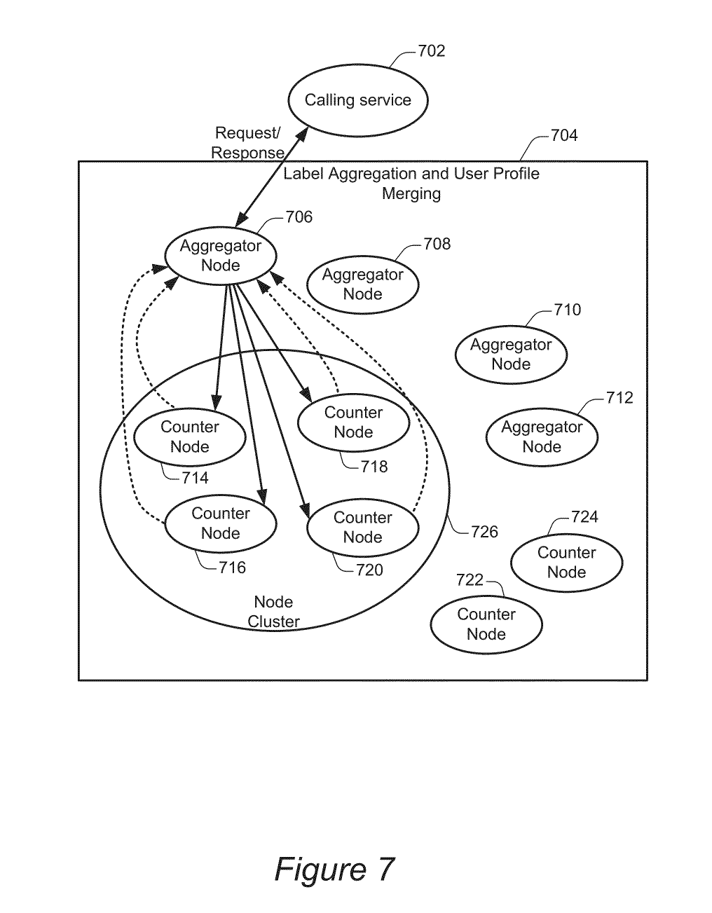

The disclosed techniques of the present invention may be implemented in any system or any suitable combination of software and/or hardware, such as distributed network of processors. FIG. 7 illustrates an example system for executing label propagation or user profile merging queries, configured in accordance with one or more embodiments. The system illustrated in FIG. 7 includes a calling service 702 that communicates with a label propagation and user profile merging system 704. The system 704 includes aggregator nodes 706-712 and counter nodes 714-724. Several of the counter nodes are included within a counter node sub-cluster 726.

According to various embodiments, a node may be a server having a processor and memory. Alternately, different nodes may be implemented on different processors within a server.

In order to handle a larger user data size, the user data may be distributed over a set of servers. Since the queries are easily parallelizable, overall system latency may be significantly reduced. Also, the results from many queries over a single sample may be calculated simultaneously.

According to various embodiments, the calling service 702 represents any system configured to transmit a query request to the system 704. For instance, the calling service 702 may be a system configured to receive request information from advertisers and formulate reporting queries based on the request information. The system 704 includes a collection of counter nodes and aggregator nodes that together can receive a query request, execute the query request, and return a result.

The aggregator nodes 706-712 receive requests from calling services and coordinate query activity among the counter nodes. In some embodiments, each clustering request is wrapped in a collector and added to a queue. When an aggregator begins processing a query request, the aggregator node selects a subcluster of counter nodes to execute the request. Then, the aggregator node distributes the query request among the selected sub-cluster of nodes.

According to various embodiments, the aggregator node receives partial results from the counter nodes and aggregates the partial responses into a final result. For instance, each counter node may perform various tasks with respect to the data sets that are present on the counter node that satisfy the query parameters. For example, each node may propagate user labels for a particular set of related devices, merge user data from related devices, etc. In particular embodiments, this distinction of responsibilities may allow the system to process an increasing amount of data while adding only a relatively small constant overhead of network communication and the increased time of partial report aggregation as new servers are introduced.

When an aggregator node receives partial responses from the counter nodes, the aggregator node may perform any necessary calculations to process the partial responses. The calling service may then complete the query based on the results received from the aggregator nodes.

According to various embodiments, label propagation and user profile merging may be performed periodically. For instance, a dataset may be updated with new user data, and a user profile merging may be initiated to reflect the updated dataset. The resulting user groups may then be stored on a network-accessible file system that can be accessed from the network nodes, such as the counter nodes within the clustering system. For instance, the user groups may be stored on a Hadoop File System (HDFS).

A “zookeeper” system may supervise the distribution of the data sets among the counter nodes and may notify each counter node when a new data set is available for that counter node. According to various embodiments, the user data may be divided into per server sub-samples. The sub-samples may have similar user data, but different observations, so that different counter nodes store different portions of the user data.

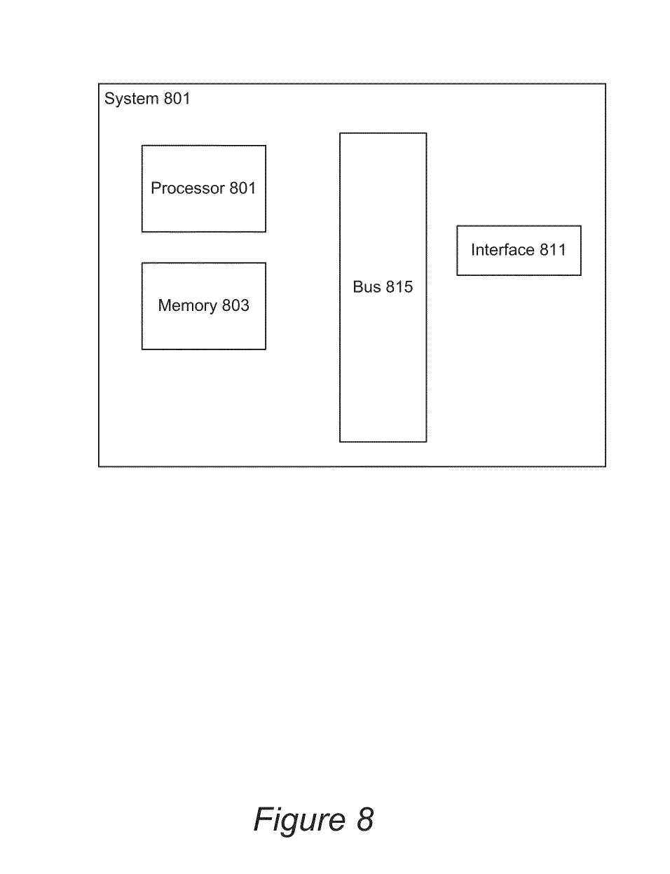

FIG. 8 illustrates one example of a server. According to particular embodiments, a system 800 suitable for implementing particular embodiments of the present invention includes a processor 801, a memory 803, an interface 811, and a bus 815 (e.g., a PCI bus or other interconnection fabric) and operates as a counter node, aggregator node, calling service, zookeeper, or any other device or service described herein. Various specially configured devices can also be used in place of a processor 801 or in addition to processor 801. The interface 811 is typically configured to send and receive data packets over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

Because such information and program instructions may be employed to implement the systems/methods described herein, the present invention relates to machine readable storage media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for facilitating on-line advertising or marketer engagement over a computer network, the method comprising:
in a processing system for facilitating on-line advertising or marketer engagement on physical user devices, obtaining a device graph that specifies a plurality of confidence metrics for pairs of a plurality of devices having a same user or a closely related set of users, wherein a first set of the devices are associated with stable user identifiers that are designated as stable and a second set of devices are associated with unstable user identifiers that are designated as unstable;
propagating specific ones of the stable user identifiers from the first set of devices to the second set of devices based on the confidence metrics, wherein each propagated stable user identifier is also propagated in association with the confidence metric of the pair of devices between which such stable user identifier is being propagated; and
designating each device in at least a portion of the second set of devices with a single one of any stable user identifiers that have been propagated to such device based on the confidence metric or combination of confidence metrics that are associated with such single stable user identifier as compared to other confidence metrics associated with other ones of any stable user identifiers that have been propagated to such device.

2. The method of claim 1, wherein propagating is performed in a plurality of cycles until a steady state is reached.

3. The method of claim 2, wherein the steady state is reached when an amount of change between a current cycle and previous cycle is less than a predefined amount.

4. The method of claim 2, wherein the label propagating is performed by a label propagation algorithm.

5. The method of claim 2, wherein each single stable user identifier that is designated for each device has an associated highest confidence metric total, wherein each confidence metric is a probability value for the associated pair of devices being a same user or a closely related set of users.

6. The method of claim 5, wherein at least one of the single stable user identifiers that is designated for a particular device is designated based on adding two or more confidence metrics associated with a particular stable user identifier that has been propagated to such particular device.

7. The method of claim 1, wherein the propagating is triggered by an online advertising event.

8. The method of claim 1, further comprising:
for a particular stable user identifier, merging user profile data associated with the devices that are associated with the particular stable user identifier to form merged user profile data.

9. The method of claim 8, wherein only portions of user profile data that are associated with access rights that allow merging are merged together.

10. The method of claim 9, further comprising:
separately maintaining user profile data for each device associated with the particular stable user identifier.

11. The method of claim 10, wherein merging is triggered by an online advertising event that pertains to at least one of the devices associated with the particular stable user identifier.

12. A system for facilitating on-line advertising or marketer engagement on physical user devices over a computer network, the system comprising at least a processor and a memory, wherein the processor and/or memory are configured to perform the following operations:
obtaining a device graph that specifies a plurality of confidence metrics for pairs of a plurality of devices having a same user or a closely related set of users, wherein a first set of the devices are associated with stable user identifiers that are designated as stable and a second set of devices are associated with unstable user identifiers that are designated as unstable;
propagating specific ones of the stable user identifiers from the first set of devices to the second set of devices based on the confidence metrics, wherein each propagated stable user identifier is also propagated in association with the confidence metric of the pair of devices between which such stable user identifier is being propagated; and
designating each device in at least a portion of the second set of devices with a single one of any stable user identifiers that have been propagated to such device based on the confidence metric or combination of confidence metrics that are associated with such single stable user identifier as compared to other confidence metrics associated with other ones of any stable user identifiers that have been propagated to such device.

13. The system of claim 12, wherein propagating is performed in a plurality of cycles until a steady state is reached.

14. The system of claim 13, wherein the steady state is reached when an amount of change between a current cycle and previous cycle is less than a predefined amount.

15. The system of claim 13, wherein the label propagating is performed by a label propagation algorithm.

16. The system of claim 13, wherein each single stable user identifier that is designated for each device has an associated highest confidence metric total, wherein each confidence metric is a probability value for the associated pair of devices being a same user or a closely related set of users.

17. The system of claim 16, wherein at least one of the single stable user identifiers that is designated for a particular device is designated based on adding two or more confidence metrics associated with a particular stable user identifier that has been propagated to such particular device.

18. The system of claim 12, wherein the propagating is triggered by an online advertising event

19. The system of claim 12, wherein the processor and/or memory are further configured for:
merging, for a particular stable user identifier, user profile data associated with the devices that are associated with the particular stable user identifier to form merged user profile data.

20. The system of claim 19, wherein only portions of user profile data that are associated with access rights that allow merging are merged together.

21. The system of claim 20, wherein the processor and/or memory are further configured for:
separately maintaining user profile data for each device associated with the particular stable user identifier.

22. The system of claim 21, wherein merging is triggered by an online advertising event that pertains to at least one of the devices associated with the particular stable user identifier.

23. At least one non-transitory computer readable storage medium having computer program instructions stored thereon that are arranged to perform the following operations:
in a processing system for facilitating on-line advertising or marketer engagement on physical user devices, obtaining a device graph that specifies a plurality of confidence metrics for pairs of a plurality of devices having a same user or a closely related set of users, wherein a first set of the devices are associated with stable user identifiers that are designated as stable and a second set of devices are associated with unstable user identifiers that are designated as unstable;
propagating specific ones of the stable user identifiers from the first set of devices to the second set of devices based on the confidence metrics, wherein each propagated stable user identifier is also propagated in association with the confidence metric of the pair of devices between which such stable user identifier is being propagated; and
designating each device in at least a portion of the second set of devices with a single one of any stable user identifiers that have been propagated to such device based on the confidence metric or combination of confidence metrics that are associated with such single stable user identifier as compared to other confidence metrics associated with other ones of any stable user identifiers that have been propagated to such device.
